(19) United States
(12) Patent Application Publication
(10) Pub. No.: US 2024/0184307 A1
(43) Pub. Date: Jun. 6, 2024

(54) TWO-WHEELED ROBOT CONTROL METHOD AND APPARATUS, MEDIUM, PROGRAM, AND ROBOT

(71) Applicant: TENCENT TECHNOLOGY (SHENZHEN) COMPANY LIMITED, Shenzhen (CN)

(72) Inventor: Jingfan ZHANG, Shenzhen (CN)

(21) Appl. No.: 18/441,470

(22) Filed: Feb. 14, 2024

Related U.S. Application Data
(63) Continuation of application No. PCT/CN2023/120933, filed on Sep. 25, 2023.

(30) Foreign Application Priority Data
Sep. 30, 2022 (CN) 202211208634.7

(51) Int. Cl. G05D 1/495; G05D 109/10

(52) U.S. Cl. CPC G05D 1/495; G05D 2109/13

(57) ABSTRACT

A robot control method includes calculating an optimal feedback gain, an optimal variable matrix, and uncertainty according to a first state variable and a first feedback gain of a robot. The optimal variable matrix represents a degree of a gain that a motion state of the robot has on a control mode of the robot. The method further includes calculating an angle deviation matrix and a noise deviation matrix according to the optimal feedback gain, the optimal variable matrix, the uncertainty, and a second state variable of the robot, obtaining a control torque of the robot according to the second state variable, the optimal feedback gain, the angle deviation matrix, and the noise deviation matrix, and controlling the robot according to the control torque.

### CROSS-REFERENCE TO RELATED APPLICATIONS

This application is a continuation of International Application No. PCT/CN2023/120933, filed on Sep. 25, 2023, which claims priority to Chinese Patent Application No. 202211208634.7, filed with the China National Intellectual Property Administration on Sep. 30, 2022 and entitled “TWO-WHEELED ROBOT CONTROL METHOD AND APPARATUS, MEDIUM, PROGRAM, AND ROBOT,” the entire contents of which are incorporated herein by reference.

### FIELD OF THE TECHNOLOGY

This application relates to the field of artificial intelligence technologies, and in particular to control of a two-wheeled robot.

### BACKGROUND OF THE DISCLOSURE

Two-wheeled robots include a balance car, a two-wheeled wheel-legged robot, a two-wheeled robot with another upper body form (a humanoid form), and the like. Therefore, how to maintain balance of a two-wheeled robot in a stationary state is a subject worth studying.

To ensure that a two-wheeled robot maintains balance in a stationary state, in the related art, a form of the two-wheeled robot is collected by a sensor, and a center of mass of the two-wheeled robot is estimated through the form of the two-wheeled robot. Then a pitch angle and a linear speed of the two-wheeled robot are adjusted according to a motor torque of the wheels, to make a line connecting the center of mass of the two-wheeled robot and a center between the wheels perpendicular to the ground, so that the balance of the two-wheeled robot in a stationary state can be ensured.

However, due to changes of operating conditions (such as changes of a self-structure, an external environment, and load) and state estimation errors (such as center estimation errors and sensor installation errors), a balance controller cannot maintain optimality of an initial design during operation, and consequently, a balance effect is affected.

### SUMMARY

In accordance with the disclosure, there is provided a robot control method including calculating an optimal feedback gain, an optimal variable matrix, and uncertainty according to a first state variable and a first feedback gain of a robot. The optimal variable matrix represents a degree of a gain that a motion state of the robot has on a control mode of the robot. The method further includes calculating an angle deviation matrix and a noise deviation matrix according to the optimal feedback gain, the optimal variable matrix, the uncertainty, and a second state variable of the robot, obtaining a control torque of the robot according to the second state variable, the optimal feedback gain, the angle deviation matrix, and the noise deviation matrix, and controlling the robot according to the control torque.

Also in accordance with the disclosure, there is provided a robot including one or more memories storing one or more computer programs, and one or more processors configured to execute the one or more computer programs to calculate an optimal feedback gain, an optimal variable matrix, and uncertainty according to a first state variable and a first feedback gain of the robot. The optimal variable matrix represents a degree of a gain that a motion state of the robot has on a control mode of the robot. The one or more processors are further configured to execute the one or more computer programs to calculate an angle deviation matrix and a noise deviation matrix according to the optimal feedback gain, the optimal variable matrix, the uncertainty, and a second state variable of the robot, obtain control torque of the robot according to the second state variable, the optimal feedback gain, the angle deviation matrix, and the noise deviation matrix, and control the robot according to the control torque.

Also in accordance with the disclosure, there is provided a non-transitory computer-readable storage medium storing one or more computer programs that, when executed by one or more processors, cause the one or more processors to calculate an optimal feedback gain, an optimal variable matrix, and uncertainty according to a first state variable and a first feedback gain of the robot. The optimal variable matrix represents a degree of a gain that a motion state of the robot has on a control mode of the robot. The one or more computer programs further cause the one or more processors to calculate an angle deviation matrix and a noise deviation matrix according to the optimal feedback gain, the optimal variable matrix, the uncertainty, and a second state variable of the robot, obtain control torque of the robot according to the second state variable, the optimal feedback gain, the angle deviation matrix, and the noise deviation matrix, and control the robot according to the control torque.

### BRIEF DESCRIPTION OF THE DRAWINGS

FIG. 1 is a schematic diagram of a two-wheeled robot according to an embodiment of this application.

FIG. 2 is a schematic diagram of a two-wheeled robot control system according to an embodiment of this application.

FIG. 3 is a schematic flowchart of a two-wheeled robot control method according to an embodiment of this application.

FIG. 4 is a schematic diagram of a sagittal plane of a two-wheeled robot according to an embodiment of this application.

FIG. 5 is a schematic flowchart of a two-wheeled robot control method according to an embodiment of this application.

FIG. 6 is a graph of training data according to an embodiment of this application.

FIG. 7 is a graph of training data according to an embodiment of this application.

FIG. 8 is a graph of training data according to an embodiment of this application.

FIG. 9 is a graph of training data according to an embodiment of this application.

FIG. 10 is a graph of training data according to an embodiment of this application.

FIG. 11 is a graph of training data according to an embodiment of this application.

FIG. 12 is a graph of training data according to an embodiment of this application.

FIG. 13 is a schematic diagram of a two-wheeled robot control apparatus according to an embodiment of this application.

FIG. 14 is a schematic diagram of a structure of a controller according to an embodiment of this application.

### DESCRIPTION OF EMBODIMENTS

To make the objectives, technical solutions, and advantages of this application clearer, the following further describes implementations of this application in detail with reference to the accompanying drawings.

In this application, a prompt interface and a pop-up window may be displayed or voice prompt information may be outputted before and during relevant data of a user is collected. The prompt interface, the pop-up window, or the voice prompt information are used for prompting the user that relevant data is collected currently. In this way, in this application, only after a confirmation operation performed by the user on the prompt interface or the pop-up window is acquired, a relevant step of obtaining the relevant data of the user starts, or otherwise (that is, in response to that the confirmation operation performed by the user on the prompt interface or the pop-up window is not acquired), the relevant step of the relevant data of the user ends, that is, the relevant data of the user is not obtained. In other words, in this application, all collected user data are collected with the consent and authorization of users. The collection, use and processing of relevant user data need to comply with the relevant laws, regulations and standards of relevant countries and regions.

In this disclosure, the phrases “at least one of A, B, and C” and “at least one of A, B, or C” both mean only A, only B, only C, or any combination of A, B, and C.

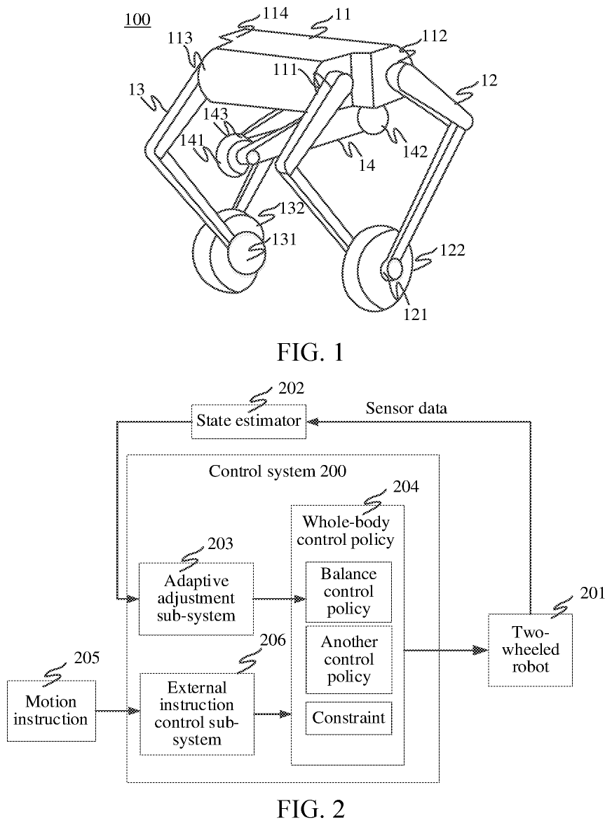

In the embodiments of this application, an example in which a two-wheeled robot is a wheel-legged two-wheeled robot is used for description. FIG. 1 is a schematic diagram of a two-wheeled robot according to an embodiment of this application. The two-wheeled robot 100 includes a base 11, a leg 12, a leg 13, and a tail rod 14.

The base 11 is provided with a controller of the two-wheeled robot. As shown in FIG. 1, the base 11 is provided with a total of four motors, a motor 111, a motor 112, a motor 113, and a motor 114. The motor 111 and the motor 112 drive the leg 12, and the motor 113 and the motor 114 drive the leg 13. In some embodiments, a position of the base 11 may be adjusted by changing a height of the leg 12 and a height of the leg 13, that is, a distance between a wheel center and a leg plane.

The leg 12 is provided with a motor 121, and the motor 121 is configured to drive a wheel 122. In some embodiments, the leg 12 uses a five-bar linkage mechanism to enable the motor 111 and the motor 112 on the base 11 to drive the leg 12, and the leg 12 has no drive on a knee.

The leg 13 is provided with a motor 131, and the motor 131 is configured to drive a wheel 132. In some embodiments, the leg 13 uses a five-bar linkage mechanism to enable the motor 113 and the motor 114 on the base 11 to drive the leg 13, and the leg 13 has no drive on a knee.

The tail rod 14 is provided with a motor 141 and a motor 142. In some embodiments, the motor 141 is configured to drive a wheel 143. In some embodiments, the motor 142 is configured to adjust a form of the tail rod 14. For example, the tail rod 14 has a lifted state and a lowered state. During the tail rod 14 is in the lifted state, the wheel 143 is in a suspended state and not in contact with the ground, and during the tail rod 14 is in the lowered state, the wheel 143 is in contact with the ground. In some embodiments, the two-wheeled robot 100 may flexibly switches between a two-wheeled mode and a three-wheeled mode by adjusting a state of the wheel 143. In some embodiments, the wheel-legged two-wheeled robot may cross obstacles, jump, and flip. In some embodiments, a height of the wheel-legged two-wheeled robot is between 0.33 m to 0.7 m.

FIG. 1 merely shows an example form of the two-wheeled robot. The two-wheeled robot in the embodiments of this application may alternatively be another robot with two parallel wheels. An upper body form of the two-wheeled robot is not limited in the embodiments of this application.

FIG. 2 shows a schematic diagram of a two-wheeled robot control system according to an embodiment of this application. The control system 200 includes an adaptive adjustment sub-system 203 and an external instruction control sub-system 206.

A two-wheeled robot 201 obtains sensor data, and generates a state estimator 202 according to the sensor data. In some embodiments, the state estimator 202 includes at least one of a linear speed, a pitch angular velocity, a base height, and a ground slope. The adaptive adjustment sub-system 203 generates a balance control policy according to the state estimator 202, and the balance control policy is used for controlling the two-wheeled robot 201 to maintain balance.

The control system 200 obtains a motion instruction 205. In some embodiments, the motion instruction 205 includes at least one of stepping forward, stepping backward, remaining stationary, jumping, adjusting the base height, and flipping. The external instruction control sub-system 206 generates a motion control policy according to the motion instruction 205.

The control system 200 generates a whole-body control policy 204 according to the balance control policy and the motion control policy. The whole-body control policy 204 is used for controlling the two-wheeled robot 201 to move in a balance state. In some embodiments, the whole-body control policy includes at least one of the balance control policy, another control policy, and a constraint. The another control policy is used for representing a control mode other than controlling the two-wheeled robot 201 to maintain balance. The constraint is used for representing a restriction condition of the two-wheeled robot 201. The control system 200 sends the whole-body control policy 204 to the two-wheeled robot 201, and the two-wheeled robot 201 executes the whole-body control policy 204.

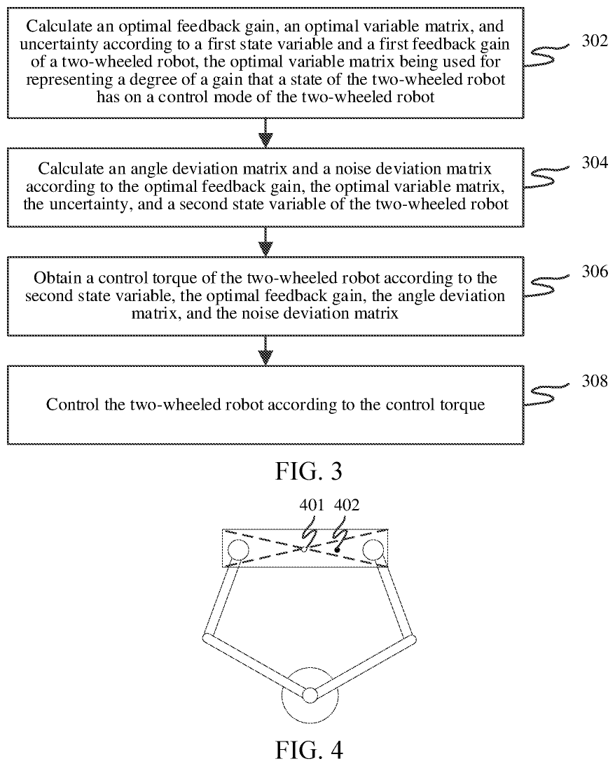

FIG. 3 shows a schematic flowchart of a two-wheeled robot control method according to an embodiment of this application. The method may be performed by a control unit (processor) controlling the two-wheeled robot shown in FIG. 1. The control unit may be disposed inside the two-wheeled robot or outside the two-wheeled robot, which is not limited in this application. In response to that the control unit is disposed inside the two-wheeled robot, the control unit may be used as a control chip of the two-wheeled robot. In response to that the control unit is disposed outside the two-wheeled robot, the control unit is disposed in a control device configured to control the two-wheeled robot.

The method includes the following processes:

Process 302: Calculate an optimal feedback gain, an optimal variable matrix, and uncertainty according to a first state variable and a first feedback gain of a two-wheeled robot, the optimal variable matrix being used for representing a degree of a gain that a motion state of the two-wheeled robot has on a control mode of the two-wheeled robot.

In the embodiments of this application, a variable matrix is a Lyapunov matrix.

The first state variable is used for representing a motion state of the two-wheeled robot measured in a first time period. In some embodiments, the first state variable includes at least one of a pitch angle, a pitch angular velocity, and a linear speed of the two-wheeled robot.

The first feedback gain is used for representing a relationship between a motion state and a control matrix of the two-wheeled robot in a balance system. For example, in the balance system, the control matrix of the two-wheeled robot τ=−K₀ζ+β. K₀ is the first feedback gain, ζ is a state variable, and β is used for representing a variation of the two-wheeled robot in motion. β can represent a time-related variable β(t), t∈[t₀, tₛ], and t₀<tₛ. The first state variable is any state variable in a time period [t₀, tₛ].

The optimal feedback gain is used for representing a relationship between a motion state and a control matrix of the stationary two-wheeled robot in a balance system.

The uncertainty is used for compensating an error of the two-wheeled robot in a motion process.

Process 304: Calculate an angle deviation matrix and a noise deviation matrix according to the optimal feedback gain, the optimal variable matrix, the uncertainty, and a second state variable of the two-wheeled robot.

The second state variable is used for representing a state of the two-wheeled robot in a second time period. In some embodiments, the second state variable includes at least one of the pitch angle, the pitch angular velocity, and the linear speed of the two-wheeled robot.

The angle deviation matrix is used for representing a difference between an actual pitch angle and a measured pitch angle of the two-wheeled robot.

The noise deviation matrix represents an ambient noise of the two-wheeled robot.

In some embodiments, in response to that the first state variable is any state variable in the time period [t₀, tₛ], the second state variable is any state variable in a second time period in (tₛ, +∞). In a specific example, the first state variable is any state variable in [1, 8], and the second state variable is a state variable in a second time period in (8, +∞). In this case, in the embodiment of this application, a state variable in a first time period is used as prior experience to determine a control torque of the two-wheeled robot according to a state variable in a second time period, and control the two-wheeled robot in the second time period according to the control torque.

Both the first state variable and the second state variable are state variables of the same type.

Process 306: Obtain a control torque of the two-wheeled robot according to the second state variable, the optimal feedback gain, the angle deviation matrix, and the noise deviation matrix.

In some embodiments, a system compensation value is obtained according to the optimal feedback gain, the angle deviation matrix, and the noise deviation matrix, and the control torque of the two-wheeled robot is obtained according to the optimal feedback gain, the second state variable, and the system compensation value.

For example, the system compensation value L=K*Z+T. K* is the optimal feedback gain, Z is the angle deviation matrix, and T is the noise deviation matrix. In this case, the control torque of the two-wheeled robot is τ=−K*ζ+L, and ζ is the second state variable.

Process 308: Control the two-wheeled robot according to the control torque.

In some implementations, as shown in FIG. 1, torques of the motor 111, the motor 112, the motor 113, the motor 114, the motor 121, and the motor 131 are controlled according to the control torque, to enable the two-wheeled robot to remain stationary in a balance state.

In conclusion, in the embodiments of this application, the optimal feedback gain, the optimal variable matrix, and the uncertainty are obtained according to the first state variable and the first feedback gain of the two-wheeled robot. The angle deviation matrix and the noise deviation matrix are calculated according to the optimal feedback gain, the optimal variable matrix, the uncertainty, and the second state variable of the two-wheeled robot. Then the control torque of the two-wheeled robot is obtained according to the second state variable, the optimal feedback gain, the angle deviation matrix, and the noise deviation matrix. Finally, the two-wheeled robot is controlled according to the control torque. According to the method, the two-wheeled robot can stay in place or move within a small range, so that stability and safety of the two-wheeled robot can be improved.

In the following embodiments, the two-wheeled robot is difficult to maintain a completely stationary standing state under different operating conditions. To make the two-wheeled robot maintain stationary, a line connecting a center of mass (COM) and a center between wheels is to be perpendicular to the ground. Therefore, it is important for a controller of the two-wheeled robot to accurately estimate a position of the center of mass. However, due to uneven mass distribution and assembly errors, it is inevitable in practice that the position of the center of mass location deviates from an expected position. This is presented in a sagittal plane in FIG. 4. Theoretically a center of mass of a base is consistent with a geometric center. However, in practice, a center of mass 402 and a geometric center 401 of a base are different.

To resolve the foregoing problems, in a task of balancing the two-wheeled robot, a motor torque τ of a control wheel needs to be adjusted, so that the pitch angle of the two-wheeled robot remains unchanged, and both the pitch angular velocity and the linear speed are adjusted to 0. In this case, a system included in the two-wheeled robot may be represented by the following equation:

\overline{\dot{ζ}}=Aζ̅+Bτ, (1)

ζ̅=[θ̅ \overline{\dot{θ}} \overline{\dot{x}}]^{T}, A∈ [symbol] ^{n×n}, and B∈ [symbol] ^{n×m} (n=3, and m=1). Due to uncertain factors of the robot system, accurate expressions of A and B are difficult to be modeled. Therefore, the accurate expressions of A and B are not applied in the embodiments of this application.

Taking into account deviation of the center of mass, an actual pitch angle θ̅ is a difference between a measured pitch angle θ and a pitch angle offset Δθ, that is, θ̅=θ−Δθ. There is no deviation between the pitch angular velocity and the linear speed. An actual pitch angular velocity \overline{\dot{θ}} is equal to a measured pitch angular velocity \dot{θ}, and an actual linear speed \overline{\dot{x}} is equal to a measured linear speed \dot{x}, that is, \overline{\dot{θ}}=\dot{θ}, and \overline{\dot{x}}=\dot{x}. In this case, the following equation is obtained:

\dot{ζ}=Aζ+Bτ+D, (2)

ζ=[θ \dot{θ} \dot{x}]^{T}, and D=D̅Δθ, D̅=[1 0 0]^{T}∈ [symbol] ^{n×q} (q=1). Because Δθ is unknown, D is also unknown. In addition, to maintain the two-wheeled robot to be stationary in a fixed location, \dot{x} is selected to be an output adjusted to 0, and an error of \dot{x} is:

e=C\dot{ζ}=Cζ, (3)

C=[0 0 1].

In the embodiments of this application, the control torque of the two-wheeled robot may be represented as the following form:

τ=−Kζ+L, (4)

L=KZ+T, Z=[Δθ 0 0]^{T}, K is a stable feedback gain, and K∈ [symbol] ^{n×1}. In the foregoing equations, the first equation is used for adjusting the motion state ζ of the two-wheeled robot, and the second equation is used for compensating the uncertainty. In response to that the two-wheeled robot is progressive stationary (satisfying lim_{t→∞}ζ̅=0), Z and T can be solved by the following adjustment equations:

0=AZ+BT+D, (5)

0=CZ, (6)

Because the unique underactuated dynamics of the two-wheeled robot, the foregoing adjustment equations have a unique solution. This is because for the two-wheeled robot in a stationary state, the motion state of the two-wheeled robot satisfies ζ=[Δθ 0 0], and in this case, the control torque of the two-wheeled robot is fixed.

In the embodiments of this application, an optimal solution of the foregoing adjustment equations is represented by solving the following constrained optimization problem of state feedback control:

min ∫₀^{∞}(ζ̅^{T}Qζ̅+Rτ²)dt, (7)

Q∈ [symbol] ^{n×n} is positive definite, and R∈ [symbol] . The optimal solution is represented by using an optimal feedback as:

K*=−R⁻¹B^{T}P*, (8)

P is the foregoing variable matrix.

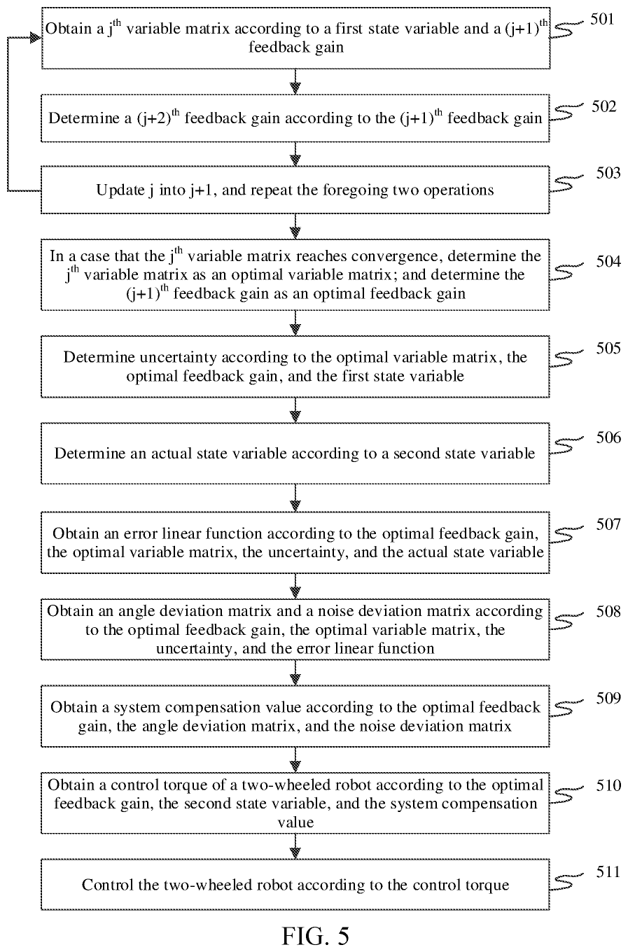

Based on the foregoing argumentation process, FIG. 5 shows a flowchart of a two-wheeled robot control method according to an embodiment of this application. The method may be performed by the two-wheeled robot 100 shown in FIG. 1. The method includes the following processes:

Process 501: Obtain a j^{th} variable matrix according to a first state variable and a (j+1)^{th} feedback gain.

The first state variable is used for representing a measured state of the two-wheeled robot in a first time period. In some embodiments, the first state variable includes at least one of a pitch angle, a pitch angular velocity, and a linear speed of the two-wheeled robot.

In some embodiments, the process includes the following sub-processes:
1. Determine a first intermediate matrix, a second intermediate matrix, and a third intermediate matrix according to the first state variable.

For example, the first intermediate matrix is denoted as Λ_{ζ,ζ}, the second intermediate matrix is denoted as Σ_{ζ,ζ}, and the third intermediate matrix is denoted as Σ_{ζ,τ}. In this case, there are following equations:

Λ_{ζ,ζ}=[ζ⊗ζ|ₜ_{₀}^{t}^{₁}, ζ⊗ζ|ₜ_{₁}^{t}^{₂}, . . . , ζ⊗ζ|ₜ_{ₙ}^{t}^{_{s−1}}]^{T}, (9)

Σ_{ζ,ζ}=[∫ₜ_{₀}^{t}^{₁}ζ⊗ζdt, ∫ₜ_{₁}^{t}^{₂}ζ⊗ζdt, . . . , ∫ₜ_{_{s−1}}^{t}^{ₙ}ζ⊗ζdt]^{T}, (10)

Σ_{ζ,τ}=[∫ₜ_{₀}^{t}^{₁}ζ⊗τdt, ∫ₜ_{₁}^{t}^{₂}ζ⊗τdt, . . . , ∫ₜ_{_{s−1}}^{t}^{ₙ}ζ⊗τdt]^{T}, (11)

ζ represents the first state variable of the two-wheeled robot, t represents time, and τ represents a control torque of the two-wheeled robot.
2. Obtain a first polynomial of a first equation according to the (j+1)^{th} feedback gain, the first intermediate matrix, the second intermediate matrix, and the third intermediate matrix.

For example, the first polynomial is denoted as

$$Ψ [ \begin{matrix}vec ( {P}_{j} ) \\ vec ( {K}_{j + 1} ) \\ vec ( {D}^{T} {P}_{j} )\end{matrix} ] .$$

Ψ=[Λ_{ζ,ζ}−2 Σ_{ζ,ζ}(Iₙ⊗Kⱼ^{T}R)−2 Σ_{ζ,τ}(Iₙ⊗R)−2 Σ_{ξ,τ}]. Iₙ and R are constant matrices, and ⊗ is used for representing a tensor product.
3. Obtain a second polynomial of the first equation according to the (j+1)^{th} feedback gain and the first intermediate matrix.

For example, the second polynomial is denoted as Φ, and Φ=−Σ_{ζ,ζ}vec(Q+Kⱼ^{T}RKⱼ). Q is a constant matrix.
4. In response to that the first polynomial is equal to the second polynomial, solve the first equation to obtain the j^{th} variable matrix.

For example, the first equation

$$Ψ [ \begin{matrix}vec ( {P}_{j} ) \\ vec ( {K}_{j + 1} ) \\ vec ( {D}^{T} {P}_{j} )\end{matrix} ] = Φ$$

is solved to obtain the j^{th} variable matrix, that is, Pⱼ in the equation.

To ensure that the first equation has a solution, a fourth intermediate matrix is determined according to the first state variable. In response to that the second intermediate matrix, the third intermediate matrix, and the fourth intermediate matrix reach full rank, sub-process 2, to be specific, obtaining a first polynomial of a first equation according to the (j+1)^{th} feedback gain, the first intermediate matrix, the second intermediate matrix, and the third intermediate matrix, is performed.

The fourth intermediate matrix is denoted as Σ_{ζ}. In this case, Σ_{ζ}=[∫ₜ_{₀}^{t}^{₁}ζdt, ∫ₜ_{₁}^{t}^{₂}ζdt, . . . , ∫ₜ_{_{s−1}}^{t}^{ₙ}ζdt]^{T}. In response to that the second intermediate matrix, the third intermediate matrix, and the fourth intermediate matrix reach full rank, the following equation is satisfied:

$$rank ( [ {Σ}_{ζ , ζ} , {Σ}_{ζ , τ} , {Σ}_{ζ} ] ) = \frac{n ( n + 1 )}{2} + n ( m + q ) = 12 , \qquad ( 12 )$$

The first intermediate matrix includes a difference between a tensor product of the first state variable and the first state variable at a first moment and a tensor product of the first state variable and the first state variable at a second moment.

The second intermediate matrix includes an integral of a tensor product of the first state variables and the first state variable between a first moment and a second moment.

The third intermediate matrix includes an integral of a tensor product of the first state variable and a torque of the two-wheeled robot between a first moment and a second moment.

The fourth intermediate matrix includes an integral of the first state variable between a first moment and a second moment.

The first moment and the second moment are two different sampling values in the first time period.

Process 502: Determine a (j+2)^{th} feedback gain according to the (j+1)^{th} feedback gain.

For example, the (j+2)^{th} feedback gain is obtained according to the first equation and the (j+1)^{th} feedback gain.

Process 503: Update j to j+1, and repeat the foregoing two processes.

For example, the foregoing two processes 501 to 502 are repeated, until a convergence condition is satisfied.

Process 504: In response to that the j^{th} variable matrix reaches convergence, determine the j^{th} variable matrix as an optimal variable matrix; and determine the (j+1)^{th} feedback gain as an optimal feedback gain.

For example, in response to that ∥Pⱼ₊₁−Pⱼ∥<ϵ, and ϵ is any positive real number, it is determined that the j^{th} variable matrix reaches convergence.

For example, the optimal variable matrix P*=Pⱼ, and the optimal feedback gain K*=Kⱼ₊₁.

Process 505: Determine uncertainty according to the optimal variable matrix, the optimal feedback gain, and the first state variable.

For example, after the optimal variable matrix P*, the optimal feedback gain K*, and the first state variable ζ are determined, the uncertainty D is determined according to the first equation.

Process 506: Determine an actual state variable according to a second state variable.

The actual state variable is used for representing an actual state of the two-wheeled robot in a second time period. The second state variable is ζ=[θ \dot{θ} \dot{x}]^{T}, and the actual state variable is ζ̅=[θ̅ \overline{\dot{θ}} \overline{\dot{x}}]^{T}. \overline{\dot{θ}}=\dot{θ}, \overline{\dot{x}}=\dot{x}, and θ̅=θ−Δθ.

Process 507: Obtain an error linear function according to the optimal feedback gain, the optimal variable matrix, the uncertainty, and the actual state variable.

In some embodiments, the process includes the following sub-processes:
1. Determine the fifth intermediate matrix, a sixth intermediate matrix, and a seventh intermediate matrix according to the actual state variable.

For example, the fifth intermediate matrix is denoted as Λ_{\hat{ζ},\hat{ζ}}, the sixth intermediate matrix is denoted as Σ_{\hat{ζ},\hat{ζ}}, and the seventh intermediate matrix is denoted as Σ_{\hat{ζ},τ}. In this case, there are following equations:

Λ_{\hat{ζ}\hat{ζ}}=[\hat{ζ}⊗\hat{ζ}|ₜ_{₀}^{t}^{₁}, \hat{ζ}⊗\hat{ζ}|ₜ_{₁}^{t}^{₂}, . . , \hat{ζ}⊗\hat{ζ}|ₜ_{ₙ}^{t}^{_{s−1}}]^{T}, (13)

Σ_{\hat{ζ},\hat{ζ}}=[∫ₜ_{₀}^{t}^{₁}\hat{ζ}⊗\hat{ζ}dt, ∫ₜ_{₁}^{t}^{₂}\hat{ζ}⊗\hat{ζ}dt, . . . , ∫ₜ_{_{s−1}}^{t}^{ₙ}\hat{ζ}⊗\hat{ζ}dt]^{T}, (14)

Σ_{\hat{ζ},τ}=[∫ₜ_{₀}^{t}^{₁}\hat{ζ}⊗τdt, ∫ₜ_{₁}^{t}^{₂}\hat{ζ}⊗τdt, . . . , ∫ₜ_{_{s−1}}^{t}^{ₙ}\hat{ζ}⊗τdt]^{T ,} (15)

\hat{ζ} represents the second state variable of the two-wheeled robot, t represents time, and τ represents the control torque of the two-wheeled robot.
2. Obtain a third polynomial of a second equation according to the optimal feedback gain, the optimal variable matrix, the uncertainty, the fifth intermediate matrix, the sixth intermediate matrix, and the seventh intermediate matrix.

For example, the third polynomial is denoted as

$$\hat{Ψ} [ \begin{matrix}vec ( {P}^{*} ) \\ vec ( {K}^{*} ) \\ vec ( ( {D}^{T} - S ( \hat{Z} ) ) {P}^{*} )\end{matrix} ] .$$

\hat{Ψ}=[Λ_{\hat{ζ},\hat{ζ}}−2 Σ_{\hat{ζ}, \hat{ζ}}(Iₙ⊗K*ⱼ^{T}R)−2 Σ_{\hat{ζ}, τ}(Iₙ⊗R)−2 Σ_{\hat{ζ},τ}]. Iₙ and R are constant matrices, and ⊗ is used for representing a tensor product.
3. Obtain a fourth polynomial of the second equation according to the second state variable and the fifth intermediate matrix.

For example, the fourth polynomial is denoted as \hat{Φ}, and \hat{Φ}=−Σ_{\hat{ζ},\hat{ζ}}vec(Q+K*ⱼ^{T}RK*). Q is a constant matrix.
4. In response to that the third polynomial is equal to the fourth polynomial, solve the second equation to obtain the error linear function.

For example, the second equation

$$\hat{Ψ} [ \begin{matrix}vec ( {P}^{*} ) \\ vec ( {K}^{*} ) \\ vec ( ( {D}^{T} - S ( \hat{Z} ) ) {P}^{*} )\end{matrix} ] = \hat{Φ}$$

is solved to obtain the error linear function, that is, S(\hat{Z}) in the equation.

To ensure that the second equation has a solution, an eighth intermediate matrix is determined according to the second state variable. In response to that the sixth intermediate matrix, the seventh intermediate matrix, and the eighth intermediate matrix reach full rank, sub-process 2, to be specific, obtaining a third polynomial of a second equation according to the optimal feedback gain, the optimal variable matrix, the uncertainty, the fifth intermediate matrix, the sixth intermediate matrix, and the seventh intermediate matrix, is performed.

For example, the eighth intermediate matrix is denoted as Σ_{\hat{ζ}}. In this case, Σ_{\hat{ζ}}=[∫ₜ_{₀}^{t}^{₁}\hat{ζ}dt, ∫ₜ_{₁}^{t}^{₂}\hat{ζ}dt, . . . , ∫ₜ_{_{s−1}}^{t}^{ₙ}\hat{ζ}dt]^{t}. In response to that the sixth intermediate matrix, the seventh intermediate matrix, and the eighth intermediate matrix reach full rank, the following equation is satisfied:

$$rank ( [ {Σ}_{\hat{ζ} , \hat{ζ}} , {Σ}_{\hat{ζ} , τ} , {Σ}_{\hat{ζ}} ] ) = \frac{n ( n + 1 )}{2} + n ( m + q ) = 12 , \qquad ( 16 )$$

The fifth intermediate matrix includes a difference between a tensor product of an actual state variable and the actual state variable at a third moment and a tensor product of the actual state variable and the actual state variable at a fourth moment.

The sixth intermediate matrix includes an integral of a tensor product of the actual state variable and the actual state variable between a third moment and a fourth moment.

The seventh intermediate matrix includes an integral of a tensor product of the actual state variable and the torque of the two-wheeled robot between a third moment and a fourth moment.

The eighth intermediate matrix includes an integral of the actual state variable between a third moment and a fourth moment.

The third moment and the fourth moment are two different sampling values in the second time period. In some embodiments, the first moment and the third moment have the same sampling rule. In some embodiments, the second moment and the fourth moment have the same sampling rule.

Process 508: Obtain an angle deviation matrix and a noise deviation matrix according to the optimal feedback gain, the optimal variable matrix, the uncertainty, and the error linear function.

For example, the optimal feedback gain K*, the optimal variable matrix P*, the uncertainty D, and the error linear function S(\hat{Z}) satisfy the following equation:

$$[ \begin{matrix}S ( \hat{Z} ) 0 - {P}^{*} {K}^{* T} R \\ \hat{Z} - I 0\end{matrix} ] [ \begin{matrix}α \\ Z \\ T\end{matrix} ] = [ \begin{matrix}D \\ 0\end{matrix} ] , \qquad ( 17 )$$

a is a scalar, and a satisfies Z=a\hat{Z} and the Equation (6). \hat{Z}=[1 0 0]^{T} is a basis of Z. In this case, the angle deviation matrix Z and the noise deviation matrix T are determined through the foregoing equations.

Process 509: Obtain a system compensation value according to the optimal feedback gain, the angle deviation matrix, and the noise deviation matrix.

For example, a system compensation value L=K*Z+T is obtained according to the optimal feedback gain K*, the angle deviation matrix Z, and the noise deviation matrix T.

Process 510: Obtain the control torque of the two-wheeled robot according to the optimal feedback gain, the second state variable, and the system compensation value.

For example, the control torque τ=−K*ζ+L of the two-wheeled robot is obtained according to the optimal feedback gain K*, the second state variable ζ, and the system compensation value L.

Process 511: Control the two-wheeled robot according to the control torque.

In some implementations, as shown in FIG. 1, torques of the motor 111, the motor 112, the motor 113, the motor 114, the motor 121, and the motor 131 are controlled according to the control torque, to enable the two-wheeled robot to remain stationary in a balance state.

In conclusion, in the embodiments of this application, the optimal feedback gain, the optimal variable matrix, and the uncertainty are obtained according to the first state variable and the first feedback gain of the two-wheeled robot. The angle deviation matrix and the noise deviation matrix are calculated according to the optimal feedback gain, the optimal variable matrix, the uncertainty, and the second state variable of the two-wheeled robot. Then the control torque of the two-wheeled robot is obtained according to the second state variable, the optimal feedback gain, the angle deviation matrix, and the noise deviation matrix. Finally, the two-wheeled robot is controlled according to the control torque. According to the method, the two-wheeled robot can stay in place or move within a small range, so that stability and safety of the two-wheeled robot can be improved.

In addition, a balance controller of the robot of the foregoing type may be automatically updated online, so that the foregoing robot can implement the optimal control, and keep stay in place or move within a small range. The foregoing effects improve stability and security of the two-wheeled robot, and enable the two-wheeled robot to be used in a scenario that requires a stable chassis and a precise operation.

In the embodiments of this application, the optimal solutions (K*, P*) and (Z, T) are needed to be determined. First, for a method to determine the optimal feedback gain K*, iteratively solve an optimization problem through the collected ζ(t) and τ(t). In the embodiments of this application, dependence on A is removed through the Lyapunov equation:

−Kⱼ^{T}RKⱼ−Q=−Aⱼ^{T}Pⱼ+PⱼAⱼ.

j is an iteration index. In addition, dependence on B is removed through the following gain iteration:

Kⱼ₊₁=R⁻¹B^{T}Pⱼ.

In each iteration process, D is set as a determined variable in each iteration, and in response to that K and P converges, convergence values are the optimal solutions K* and P*.

To determine parameters Z and T, a basis of Z is defined as \hat{Z}=[1 0 0]^{T}, so that there is a scalar a satisfying Z=a\hat{Z} and Equation (6). A Sylvester mapping S: Rⁿ→Rⁿ is defined to map, to make S(Z)=−AZ. In this case,

S(Z)≡aS(\hat{Z})=BT+D=P*K*^{T}RT+D.

B is represented by using K* and P*, and D can be solved through the foregoing processes.

In response to that S(\hat{Z}) is provided, (Z, T) can be solved through the following equation:

$$[ \begin{matrix}S ( \hat{Z} ) 0 - {P}^{*} {K}^{* T} R \\ \hat{Z} - I 0\end{matrix} ] [ \begin{matrix}α \\ Z \\ T\end{matrix} ] = [ \begin{matrix}D \\ 0\end{matrix} ] .$$

The control torque τ is obtained by setting L=K*Z+T and τ=−K*ζ+L.

In conclusion, the embodiments of this application provide a proof process of calculating the control torque τ. A complete process of calculating the control torque can be obtained through the proof process, and provides a theoretical basis for calculating the control torque.

In the following embodiments, the two-wheeled robot control method is provided in the embodiments of this application in a form of pseudocode as follows:
1. Apply initial stability control, and τ=−K₀ζ+β, a detection noise β(t) collecting data on [t₀, tₛ].
2. Calculate Equations (9), (10), (11), and (12) and Equations (13), (14), (15) and (16).
3. Determine that a full-rank condition holds:

$$rank ( [ {Σ}_{ζ , ζ} , {Σ}_{ζ , τ} , {Σ}_{ζ} ] ) = \frac{n ( n + 1 )}{2} + n ( m + q ) = 12 ; \\ rank ( [ {Σ}_{\hat{ζ} , \hat{ζ}} , {Σ}_{\hat{ζ} , τ} , {Σ}_{\hat{ζ}} ] ) = \frac{n ( n + 1 )}{2} + n ( m + q ) = 12.$$

4. Set j=0.
5. Set a loop, and let ∥Pⱼ₊₁−Pⱼ∥<ϵ as a loop end condition, ϵ being any positive real number.
6. Solve Pⱼ, Kⱼ₊₁, and D through the following equation:

$$Ψ [ \begin{matrix}vec ( {P}_{j} ) \\ vec ( {K}_{j + 1} ) \\ vec ( {D}^{T} {P}_{j} )\end{matrix} ] = Φ ,$$

where Ψ=[Λ_{ζ,ζ}−2 Σ_{ζ,ζ}(Iₙ⊗Kⱼ^{T}R)−2 Σ_{ζ,τ}(Iₙ⊗R)−2 Σ_{ξ,τ}], and
Φ=−Σ_{ζ,ζ}vec(Q+Kⱼ^{T}RKⱼ).
7. End the loop.
8. Let K*=Kⱼ₊₁, and P*=Pⱼ.
9. Solve S(\hat{Z}) through the following equation:

$$\hat{Ψ} [ \begin{matrix}vec ( {P}^{*} ) \\ vec ( {K}^{*} ) \\ vec ( ( {D}^{T} - S ( \hat{Z} ) ) {P}^{*} )\end{matrix} ] = \hat{Φ} ,$$

where \hat{Ψ}=[Λ_{\hat{ζ},\hat{ζ}}−2 Σ_{\hat{ζ},\hat{ζ}}(Iₙ⊗K*ⱼ^{T}R)−2 Σ_{\hat{ζ},τ}(Iₙ⊗R)−2 Σ_{\hat{ζ},τ}], and
\hat{Φ}=−Σ_{\hat{ζ},\hat{ζ}}vec(Q+K*ⱼ^{T}RK*).
10. Solve Z and T through Equation (17).
11. Let L=K*Z+T, the control torque outputted by the two-wheeled robot is τ=−K*ζ+L in this case.

In conclusion, in the embodiments of this application, the optimal feedback gain, the optimal variable matrix, and the uncertainty are obtained according to the first state variable and the first feedback gain of the two-wheeled robot. The angle deviation matrix and the noise deviation matrix are calculated according to the optimal feedback gain, the optimal variable matrix, the uncertainty, and the second state variable of the two-wheeled robot. Then the control torque of the two-wheeled robot is obtained according to the second state variable, the optimal feedback gain, the angle deviation matrix, and the noise deviation matrix. Finally, the two-wheeled robot is controlled according to the control torque. According to the method, the two-wheeled robot can stay in place or move within a small range, so that stability and safety of the two-wheeled robot can be improved.

In embodiments of this application train, a controller is adjusted for optimal output driven by training data of a two-wheeled robot in four scenarios, to process uncertainties in a model and disturbance. In the related art, a two-wheeled robot can maintain balance, but cannot remain stationary, and this is a restriction in the related art. Therefore, in a first scenario and a second scenario, a stability problem which occurs in response to that a height of the robot is 0.33 m and 0.5 m is avoided. In addition, in this application, two more challenging scenarios are further provided. In a third scenario, an eccentric load of 3.5 kg is arranged at a front of a base in the robot in this application. Because a weight of a floating base is 11 kg, a heavy load significantly changes a balance point of the two-wheeled robot. In a fourth scenario, the two-wheeled robot is trained on a ramp in this application. Clearly, an additional torque is needed for the two-wheeled robot to compensate factors of a slope of a direct ramp, and this means that the balance point of the two-wheeled robot changes. Information of the load (such as quality, shape, and position) and the slope (such as gradient) are not applied during a training process, and are regarded as unknown interference.

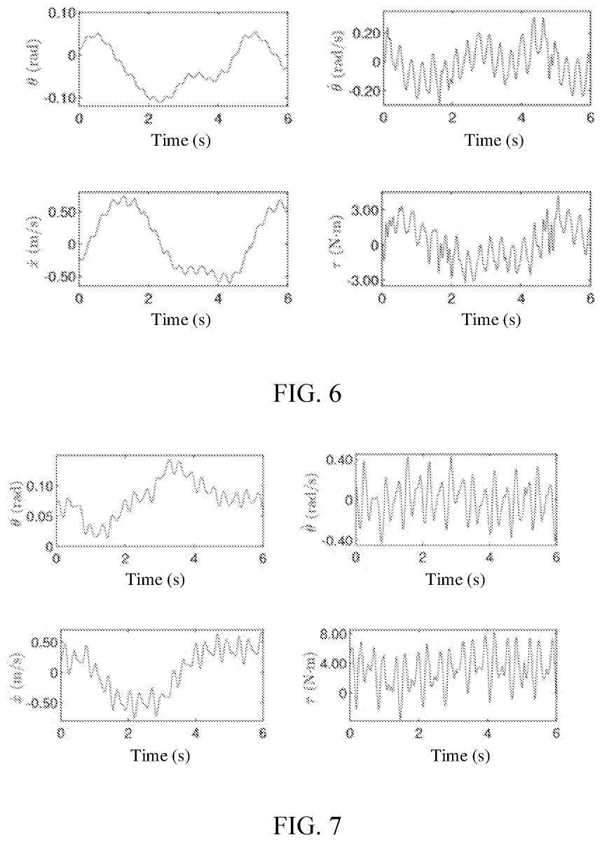

During training, an initial gain K₀=[−74 −26 −10] is used. In response to that the controller is in a stationary state, the two-wheeled robot can move upward/forward repeatedly according to the controller, and a detection noise β(t)=1.6 sin(8πt)+0.8 cos(12πt) is configured to obtain more information data. Sufficient training data is collected in each experiment to easily satisfy a full-rank condition of this application. In addition, robustness of the method provided in the embodiments of this application ensures a small neighborhood converged to the optimal solution during the use of the noise data. FIG. 6 and FIG. 7 shows training data in response to that the robot height is 0.33 m and 0.5 m respectively, and oscillation of a curve means that exploration noise exists.

Finally, by setting Q=diag(900, 400, 150), R=1, and ϵ=10⁻⁴ in the method of this application, convergence is performed on control parameters of the foregoing four scenarios as shown in the following:

K*ₐ=[−67.96 −29.13 −9.20], Lₐ=−4.21;

K*_{b}=[−80.92 −27.38 −10.79], L_{b}=−1.78;

K*_{c}=[−86.61 −27.37 −10.89], L_{c}=−5.97;

K*_{d}=[−61.04 −19.86 −7.97], L_{d}=1.30.

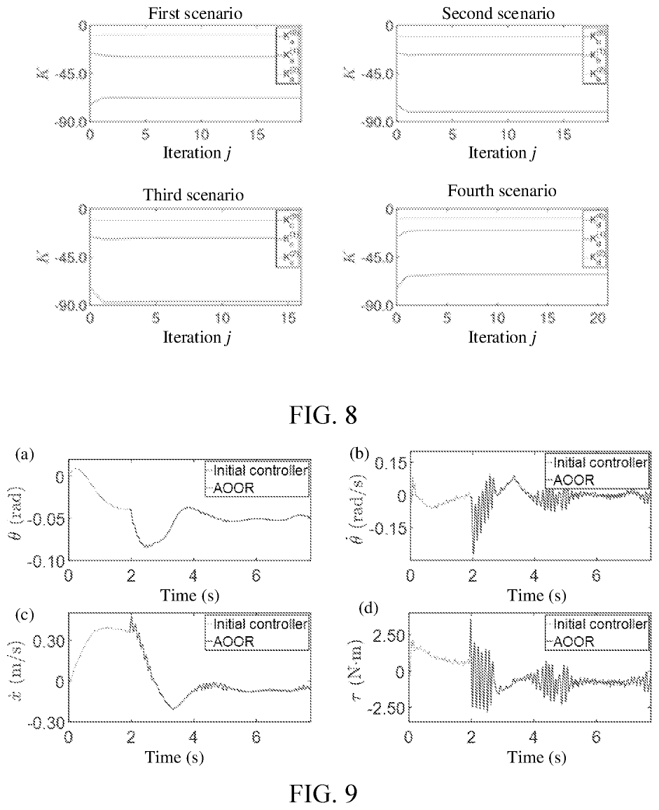

The foregoing convergence values are respectively implemented in the 19^{th}, 18^{th}, 16^{th}, 21^{st} iterations. Refer to FIG. 8. A feature of quick convergence enables an algorithm of this application to be implemented online.

Because a pitch angle of the two-wheeled robot is adjusted to be extensively large, a motor input of the two-wheeled robot is oscillating. A first diagonal term of Q is reduced accordingly in the embodiments of this application. In addition, according to a manual test, convergence property of the algorithm is sensitive to a third diagonal term, and a feasible range is 90 to 280. In addition, a second diagonal term is larger than 180, and the first diagonal term may be any positive value. These results indicate the robustness of the algorithm provided in the embodiments of this application to the convergence of the parameters Q and R.

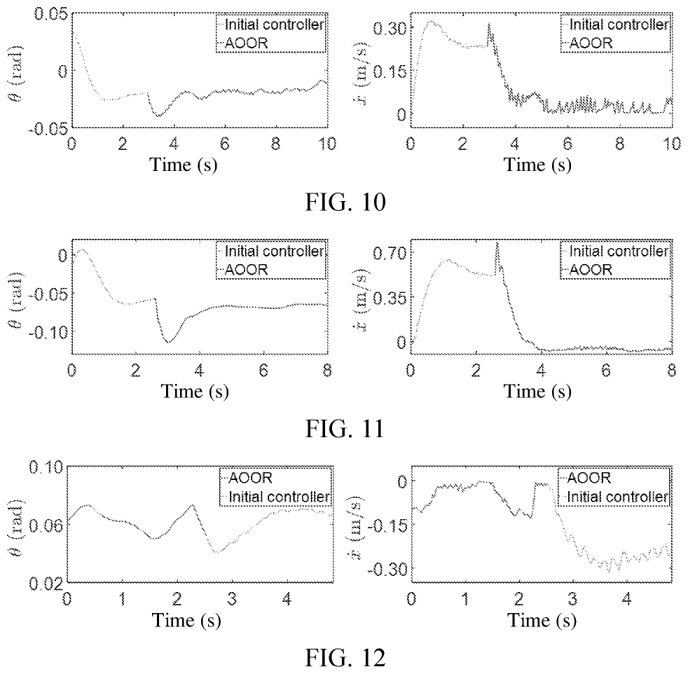

By using the algorithm of this application, a trained controller may update a motion state of the two-wheeled robot online after data collection. Here, the related art (in which the initial feedback gain K₀ is used to control the two-wheeled robot) is directly compared with the method provided in the embodiments of this application (also referred to as adaptive optimal output regulation (AOOR)), to avoid an impact of motion noise and exploration noise on vision during the training. In the first scenario, the height of the two-wheeled robot is 0.33 m. The related art is used first, and a remote controller is used to make the two-wheeled robot remain stationary. Then, after the remote controller is released, the robot continuously moves forward within the first two seconds, and this can be learned from the curve shown in FIG. 9(c). Then, by applying the method provided in the embodiments of this application at t=2 seconds, the robot decelerates sharply and maintains stationary for the next 6 seconds, as shown in the curve shown in FIG. 9(c). To implement quick adjustment, slight oscillation exists in the motor input, but impacts on the pitch angle (referring to FIG. 9(a)) and a linear speed (referring to FIG. 9(c)) are acceptable. According to test data, an average speed during the AOOR is applied is much less than that during an initial situation, and a small shift is generated in a long period. A small shift generated during the use of the method provided in the embodiments of this application is caused by an initial speed converging to zero, and this is inevitable. A testing processes for the robot is similar at a height of 0.5 m and under load. According to testing data (FIG. 10 and FIG. 11), after the method provided in this application is applied, the robot decelerates and becomes stationary. A method for a slope test is similar. A difference is that the method provided in the embodiments of this application is used at the beginning, and then the related art is used for comparison. The reason is that if the related art is used at the beginning, the robot may leave the slope quickly before the method provided in the embodiments of this application is applied. Data (FIG. 12) indicates the method provided in the embodiments of this application has significant adjustment performance. Experiment results of this application and the related art are summarized in Table 1. A small shift in a long time in the method provided in the embodiments of this application indicates that the method provided in the embodiments of this application has significant adjustment performance.

TABLE 1
Experiment results of this application and the related art

| | | | Method provided in this | |
|---|---|---|---|---|
| Experiment | Related art | | application | |
| scenario | Time (s) | Shift (m) | Time (s) | Shift (m) |
| First scenario | 2.0 | 0.46 | 5.8 | 0.15 |
| Second scenario | 2.9 | 0.56 | 7.1 | 0.15 |
| Third scenario | 2.5 | 1.01 | 5.4 | 0.04 |
| Fourth scenario | 2.3 | 0.42 | 2.5 | 0.10 |

The following are apparatus embodiments of this application. For details not described in the apparatus embodiments, reference is made to the foregoing method embodiments, and details are not described herein again.

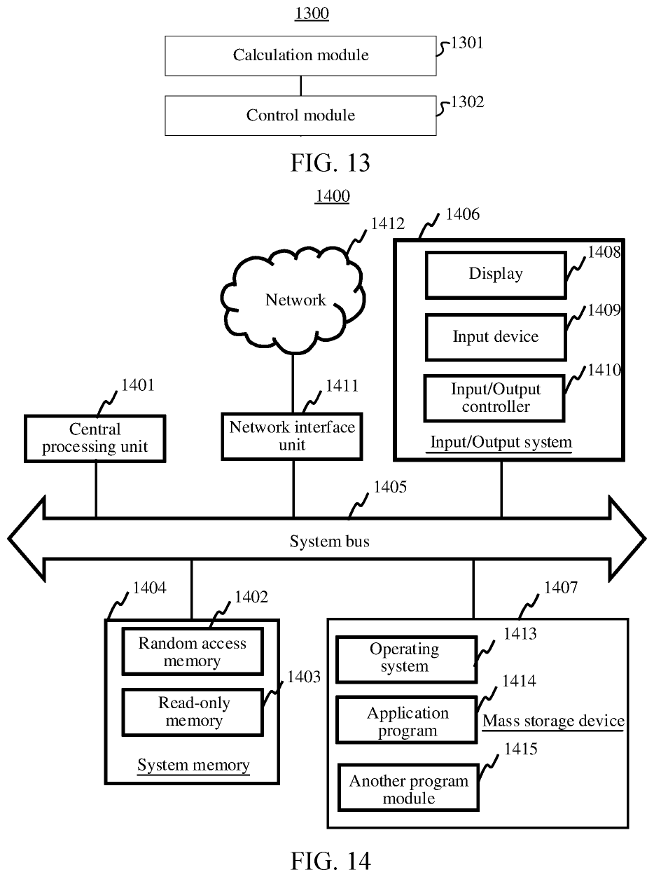

FIG. 13 is a schematic diagram of a structure of a two-wheeled robot control apparatus according to an embodiment of this application. The apparatus may be implemented as all or a part of a computer device by software, hardware, or a combination of the two. The apparatus 1300 includes:
a calculation module 1301, configured to calculate an optimal feedback gain, an optimal variable matrix, and uncertainty according to a first state variable and a first feedback gain of a two-wheeled robot, the optimal variable matrix being used for representing a degree of gain that a motion state of the two-wheeled robot has on a control mode of the two-wheeled robot;
the calculation module 1301 being further configured to calculate an angle deviation matrix and a noise deviation matrix according to the optimal feedback gain, the optimal variable matrix, the uncertainty, and a second state variable of the two-wheeled robot; and
the calculation module 1301 being further configured to obtain a control torque of the two-wheeled robot according to the second state variable, the optimal feedback gain, the angle deviation matrix, and the noise deviation matrix; and
a control module 1302, configured to control the two-wheeled robot according to the control torque.

In one embodiment, the calculation module 1301 is further configured to: obtain a j^{th} variable matrix according to the first state variable and a (j+1)^{th} feedback gain, the 1^{st} feedback gain being the first feedback gain, j being an integer, and an initial value of j being 0; determine a (j+2)^{th} feedback gain according to the (j+1)^{th} feedback gain; update j to j+1, and repeat the foregoing two operations; in response to that the j^{th} variable matrix reaches convergence, determine the j^{th} variable matrix as the optimal variable matrix; determine the (j+1)^{th} feedback gain as the optimal feedback gain; and determine the uncertainty according to the optimal variable matrix, the optimal feedback gain, and the first state variable.

In one embodiment, the calculation module 1301 is further configured to: determine a first intermediate matrix, a second intermediate matrix, and a third intermediate matrix according to the first state variable; obtain a first polynomial of a first equation according to the (j+1)^{th} feedback gain, the first intermediate matrix, the second intermediate matrix, and the third intermediate matrix; obtain a second polynomial of the first equation according to the (j+1)^{th} feedback gain and the first intermediate matrix; and in response to that the first polynomial is equal to the second polynomial, solve the first equation to obtain the j^{th} variable matrix.

In one embodiment, the calculation module 1301 is further configured to: determine a fourth intermediate matrix according to the first state variable; and in response to that the second intermediate matrix, the third intermediate matrix, and the fourth intermediate matrix reach full rank, perform the operation of obtaining a first polynomial of a first equation according to the (j+1)^{th} feedback gain, the first intermediate matrix, the second intermediate matrix, and the third intermediate matrix.

In one embodiment, the first intermediate matrix includes a difference between a tensor product of a first state variable and the first state variable at a first moment and a tensor product of the first state variable and the first state variable at a second moment. The second intermediate matrix includes an integral of a tensor product of the first state variable and the first state variable between a first moment and a second moment. The third intermediate matrix includes an integral of a tensor product of a first state variable and a torque of the two-wheeled robot between the first moment and a second moment. The fourth intermediate matrix includes an integral of the first state variable between a first moment and a second moment.

In one embodiment, the calculation module 1301 is further configured: to determine actual state variable according to the second state variable; obtain an error linear function according to the optimal feedback gain, the optimal variable matrix, the uncertainty, and the actual state variable; and obtain the angle deviation matrix and the noise deviation matrix according to the optimal feedback gain, the optimal variable matrix, the uncertainty, and the error linear function.

In one embodiment, the calculation module 1301 is further configured to: determine a fifth intermediate matrix, a sixth intermediate matrix, and a seventh intermediate matrix according to the actual state variable; obtain a third polynomial of a second equation according to the optimal feedback gain, the optimal variable matrix, the uncertainty, the fifth intermediate matrix, the sixth intermediate matrix, and the seventh intermediate matrix; obtain a fourth polynomial of the second equation according to the actual state variable and the fifth intermediate matrix; and in response to that the third polynomial is equal to the fourth polynomial, solve the second equation to obtain the error linear function.

In one embodiment, the calculation module 1301 is further configured to: determine an eighth intermediate matrix according to the actual state variable; in response to that the sixth intermediate matrix, the seventh intermediate matrix, and the eighth intermediate matrix reach full rank, perform the operation of obtaining a third polynomial of a second equation according to the optimal feedback gain, the optimal variable matrix, the uncertainty, the fifth intermediate matrix, the sixth intermediate matrix, and the seventh intermediate matrix.

In one embodiment, the fifth intermediate matrix includes a difference between a tensor product of a second state variable and the second state variable at a third moment and a tensor product of the second state variable and the second state variable at a fourth moment. The sixth intermediate matrix includes an integral of a tensor product of the second state variable and the second state variable between a third moment and a fourth moment. The seventh intermediate matrix includes an integral of a tensor product of the second state variable and the torque of the two-wheeled robot between a third moment and a fourth moment. The eighth intermediate matrix includes an integral of the second state variable between a third moment and a fourth moment.

In one embodiment, the calculation module 1301 is further configured to: obtain a system compensation value according to the optimal feedback gain, the angle deviation matrix, and the noise deviation matrix; and obtain the control torque of the two-wheeled robot according to the optimal feedback gain, the second state variable, and the system compensation value.

In conclusion, in the embodiments of this application, the optimal feedback gain, the optimal variable matrix, and the uncertainty are obtained according to the first state variable and the first feedback gain of the two-wheeled robot. The angle deviation matrix and the noise deviation matrix are calculated according to the optimal feedback gain, the optimal variable matrix, the uncertainty, and the second state variable of the two-wheeled robot. Then the control torque of the two-wheeled robot is obtained according to the second state variable, the optimal feedback gain, the angle deviation matrix, and the noise deviation matrix. Finally, the two-wheeled robot is controlled according to the control torque. According to the method, the two-wheeled robot can stay in place or move within a small range, so that stability and safety of the two-wheeled robot can be improved.

FIG. 14 is a schematic diagram of a structure of a controller according to an exemplary embodiment. A computer device 1400 includes a central processing unit (CPU) 1401, a system memory 1404 including a random access memory (RAM) 1402 and a read-only memory (ROM) 1403, and a system bus 1405 connecting the system memory 1404 and the central processing unit 1401. The computer device 1400 further includes a basic input/output system (I/O system) 1406 assisting in transmitting information between components in the computer device, and a mass storage device 1407 configured to store an operating system 1413, an application program 1414, and another program module 1415.

The basic input/output system 1406 includes a display 1408 configured to display information and an input device 1409 such as a mouse or a keyboard configured to input information by a user. The display 1408 and the input device 1409 are both connected to the central processing unit 1401 by using an input/output controller 1410 connected to the system bus 1405. The basic input/output system 1406 may further include the input/output controller 1410 to be configured to receive and process inputs from a plurality of other devices such as a keyboard, a mouse, and an electronic stylus. Similarly, the input/output controller 1410 further provides an output to a display screen, a printer, or another type of output device.

The mass storage device 1407 is connected to the central processing unit 1401 by using a mass storage controller (not shown) connected to the system bus 1405. The mass storage device 1407 and a computer device-readable medium associated with the mass storage device provide non-volatile storage to the computer device 1400. To be specific, the mass storage device 1407 may include a computer device-readable medium (not shown) such as a hard disk or a compact disc read-only memory (CD-ROM) drive.

In general, the computer device-readable medium may include a computer device storage medium and a communication medium. The computer device storage medium includes volatile and non-volatile media, and removable and non-removable media implemented by using any method or technology used for storing information such as computer device-readable instructions, data structures, program modules, or other data. The computer device storage medium includes a RAM, a ROM, an erasable programmable read-only memory (EPROM), an electrically erasable programmable read-only memory (EEPROM), a CD-ROM, a digital versatile disc (DVD) or another optical storage, a magnetic cassette, a magnetic tape, a disk storage, or another magnetic storage device. Certainly, a person skilled in the art may know that the computer device storage medium is not limited to the foregoing several types. The system memory 1404 and the mass storage device 1407 may be collectively referred to as a memory.

According to the embodiments of the present disclosure, the computer device 1400 may alternatively be connected, through a network such as the Internet, to a remote computer device on the network and run. To be specific, the computer device 1400 may be connected to a network 1411 by using a network interface unit 1412 connected to the system bus 1405, or may be connected to another type of network or a remote computer device system (not shown) by using a network interface unit 1412.

The memory further includes one or more programs. The one or more programs are stored in a memory. The central processing unit 1401 implements all or some processes of the two-wheeled robot control method by executing the one or more programs.

In addition, an embodiment of this application further provides a storage medium, the storage medium being configured to store a computer program, and the computer program being used for performing the two-wheeled robot control method according to the foregoing embodiments.

An embodiment of this application further provides a computer program product including a computer program, the computer program product, when running on a computer, causing the computer to perform the two-wheeled robot control method according to the foregoing embodiments.

The sequence numbers of the foregoing embodiments of this application are merely for description purpose but do not imply the preference among the embodiments.

A person of ordinary skill in the art may understand that all or some of the processes of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

Embodiments of the present disclosure are described using a two-wheeled robot as an example. The present disclosure, however, is not limited thereto, but is applicable to any suitable robot.

The foregoing descriptions are merely optional embodiments of this application, but are not intended to limit this application. Any modification, equivalent replacement, or improvement made within the spirit and principle of this application fall within the scope of this application.

What is claimed is:

1. A robot control method comprising:
calculating an optimal feedback gain, an optimal variable matrix, and uncertainty according to a first state variable and a first feedback gain of a robot, the optimal variable matrix representing a degree of a gain that a motion state of the robot has on a control mode of the robot;
calculating an angle deviation matrix and a noise deviation matrix according to the optimal feedback gain, the optimal variable matrix, the uncertainty, and a second state variable of the robot;
obtaining a control torque of the robot according to the second state variable, the optimal feedback gain, the angle deviation matrix, and the noise deviation matrix; and
controlling the robot according to the control torque.

2. The method according to claim 1, wherein calculating the optimal feedback gain, the optimal variable matrix, and the uncertainty according to the first state variable and the first feedback gain of the robot includes:
obtaining a j^{th} variable matrix according to the first state variable and a (j+1)^{th} feedback gain, j being an integer and having an initial value of 0;
determining a (j+2)^{th} feedback gain according to the (j+1)^{th} feedback gain;
updating j to j+1, and repeating operations of obtaining the j^{th} variable matrix and determining the (j+2)^{th} feedback gain until the j^{th} variable matrix reaches convergence;
in response to the j^{th} variable matrix reaching convergence, determining the j^{th} variable matrix as the optimal variable matrix, and determining the (j+1)^{th} feedback gain as the optimal feedback gain; and
determining the uncertainty according to the optimal variable matrix, the optimal feedback gain, and the first state variable.

3. The method according to claim 2, wherein obtaining the j^{th} variable matrix according to the first state variable and the (j+1)^{th} feedback gain includes:
determining a first intermediate matrix, a second intermediate matrix, and a third intermediate matrix according to the first state variable;
obtaining a first polynomial of an equation according to the (j+1)^{th} feedback gain, the first intermediate matrix, the second intermediate matrix, and the third intermediate matrix;
obtaining a second polynomial of the equation according to the (j+1)^{th} feedback gain and the first intermediate matrix; and
solving the equation with the first polynomial being equal to the second polynomial to obtain the j^{th} variable matrix.

4. The method according to claim 3, further comprising:
determining a fourth intermediate matrix according to the first state variable; and
in response to the second intermediate matrix, the third intermediate matrix, and the fourth intermediate matrix reaching full rank, performing operation of obtaining the first polynomial of the equation according to the (j+1)^{th} feedback gain, the first intermediate matrix, the second intermediate matrix, and the third intermediate matrix.

5. The method according to claim 4, wherein:
the first intermediate matrix includes a difference between a tensor product of the first state variable and the first state variable at a first moment and a tensor product of the first state variable and the first state variable at a second moment;
the second intermediate matrix includes an integral of a tensor product of the first state variable and the first state variable between the first moment and the second moment;
the third intermediate matrix includes an integral of a tensor product of the first state variable and a torque of the robot between the first moment and the second moment; and
the fourth intermediate matrix includes an integral of the first state variable between the first moment and the second moment.

6. The method according to claim 1, wherein calculating the angle deviation matrix and the noise deviation matrix according to the optimal feedback gain, the optimal variable matrix, the uncertainty, and the second state variable includes:
determining an actual state variable according to the second state variable;
obtaining an error linear function according to the optimal feedback gain, the optimal variable matrix, the uncertainty, and the actual state variable; and
obtaining the angle deviation matrix and the noise deviation matrix according to the optimal feedback gain, the optimal variable matrix, the uncertainty, and the error linear function.

7. The method according to claim 6, wherein obtaining the error linear function according to the optimal feedback gain, the optimal variable matrix, the uncertainty, and the actual state variable includes:
determining a first intermediate matrix, a second intermediate matrix, and a third intermediate matrix according to the actual state variable;
obtaining a first polynomial of an equation according to the optimal feedback gain, the optimal variable matrix, the uncertainty, the first intermediate matrix, the second intermediate matrix, and the third intermediate matrix;
obtaining a second polynomial of the equation according to the actual state variable and the first intermediate matrix; and
solving the equation with the first polynomial being equal to the second polynomial to obtain the error linear function.

8. The method according to claim 7, further comprising:
determining a fourth intermediate matrix according to the actual state variable; and
in response to the second intermediate matrix, the third intermediate matrix, and the fourth intermediate matrix reaching full rank, performing operation of obtaining the first polynomial of the equation according to the optimal feedback gain, the optimal variable matrix, the uncertainty, the first intermediate matrix, the second intermediate matrix, and the third intermediate matrix.

9. The method according to claim 8, wherein:
the first intermediate matrix includes a difference between a tensor product of the actual state variable and the actual state variable at a first moment and a tensor product of the actual state variable and the actual state variable at a second moment;
the second intermediate matrix includes an integral of a tensor product of the actual state variable and the actual state variable between the first moment and the second moment;
the third intermediate matrix includes an integral of a tensor product of the actual state variable and a torque of the robot between the first moment and the second moment; and
the fourth intermediate matrix includes an integral of the actual state variable between the first moment and the second moment.

10. The method according to claim 1, wherein obtaining the control torque of the robot according to the second state variable, the optimal feedback gain, the angle deviation matrix, and the noise deviation matrix includes:
obtaining a system compensation value according to the optimal feedback gain, the angle deviation matrix, and the noise deviation matrix; and
obtaining the control torque of the robot according to the optimal feedback gain, the second state variable, and the system compensation value.

11. A robot comprising:
one or more memories storing one or more computer programs; and
one or more processors configured to execute the one or more computer programs to:
calculate an optimal feedback gain, an optimal variable matrix, and uncertainty according to a first state variable and a first feedback gain of the robot, the optimal variable matrix representing a degree of a gain that a motion state of the robot has on a control mode of the robot;
calculate an angle deviation matrix and a noise deviation matrix according to the optimal feedback gain, the optimal variable matrix, the uncertainty, and a second state variable of the robot;
obtain control torque of the robot according to the second state variable, the optimal feedback gain, the angle deviation matrix, and the noise deviation matrix; and
control the robot according to the control torque.

12. The robot according to claim 11, wherein the one or more processors are further configured to execute the one or more computer programs to:
obtain a j^{th} variable matrix according to the first state variable and a (j+1)^{th} feedback gain, j being an integer and having an initial value of 0;
determine a (j+2)^{th} feedback gain according to the (j+1)^{th} feedback gain;
update j to j+1, and repeating operations of obtaining the j^{th} variable matrix and determining the (j+2)^{th} feedback gain until the j^{th} variable matrix reaches convergence;
in response to the j^{th} variable matrix reaching convergence, determine the j^{th} variable matrix as the optimal variable matrix, and determining the (j+1)^{th} feedback gain as the optimal feedback gain; and
determine the uncertainty according to the optimal variable matrix, the optimal feedback gain, and the first state variable.

13. The robot according to claim 12, wherein the one or more processors are further configured to execute the one or more computer programs to:
determine a first intermediate matrix, a second intermediate matrix, and a third intermediate matrix according to the first state variable;
obtain a first polynomial of an equation according to the (j+1)^{th} feedback gain, the first intermediate matrix, the second intermediate matrix, and the third intermediate matrix;
obtain a second polynomial of the equation according to the (j+1)^{th} feedback gain and the first intermediate matrix; and
solve the equation with the first polynomial being equal to the second polynomial to obtain the j^{th} variable matrix.

14. The robot according to claim 13, wherein the one or more processors are further configured to execute the one or more computer programs to:
determine a fourth intermediate matrix according to the first state variable; and
in response to the second intermediate matrix, the third intermediate matrix, and the fourth intermediate matrix reaching full rank, perform operation of obtaining the first polynomial of the equation according to the (j+1)^{th} feedback gain, the first intermediate matrix, the second intermediate matrix, and the third intermediate matrix.

15. The robot according to claim 14, wherein:
the first intermediate matrix includes a difference between a tensor product of the first state variable and the first state variable at a first moment and a tensor product of the first state variable and the first state variable at a second moment;
the second intermediate matrix includes an integral of a tensor product of the first state variable and the first state variable between the first moment and the second moment;
the third intermediate matrix includes an integral of a tensor product of the first state variable and a torque of the robot between the first moment and the second moment; and
the fourth intermediate matrix includes an integral of the first state variable between the first moment and the second moment.

16. The robot according to claim 11, wherein the one or more processors are further configured to execute the one or more computer programs to:
determine an actual state variable according to the second state variable;
obtain an error linear function according to the optimal feedback gain, the optimal variable matrix, the uncertainty, and the actual state variable; and
obtain the angle deviation matrix and the noise deviation matrix according to the optimal feedback gain, the optimal variable matrix, the uncertainty, and the error linear function.

17. The robot according to claim 16, wherein the one or more processors are further configured to execute the one or more computer programs to:
determine a first intermediate matrix, a second intermediate matrix, and a third intermediate matrix according to the actual state variable;
obtain a first polynomial of an equation according to the optimal feedback gain, the optimal variable matrix, the uncertainty, the first intermediate matrix, the second intermediate matrix, and the third intermediate matrix;
obtain a second polynomial of the equation according to the actual state variable and the first intermediate matrix; and
solve the equation with the first polynomial being equal to the second polynomial to obtain the error linear function.

18. The robot according to claim 17, wherein the one or more processors are further configured to execute the one or more computer programs to:
determine a fourth intermediate matrix according to the actual state variable; and
in response to the second intermediate matrix, the third intermediate matrix, and the fourth intermediate matrix reaching full rank, perform operation of obtaining the first polynomial of the equation according to the optimal feedback gain, the optimal variable matrix, the uncertainty, the first intermediate matrix, the second intermediate matrix, and the third intermediate matrix.

19. The robot according to claim 18, wherein:
the first intermediate matrix includes a difference between a tensor product of the actual state variable and the actual state variable at a first moment and a tensor product of the actual state variable and the actual state variable at a second moment;
the second intermediate matrix includes an integral of a tensor product of the actual state variable and the actual state variable between the first moment and the second moment;
the third intermediate matrix includes an integral of a tensor product of the actual state variable and a torque of the robot between the first moment and the second moment; and
the fourth intermediate matrix includes an integral of the actual state variable between the first moment and the second moment.

20. A non-transitory computer-readable storage medium storing one or more computer programs that, when executed by one or more processors, cause the one or more processors to:
calculate an optimal feedback gain, an optimal variable matrix, and uncertainty according to a first state variable and a first feedback gain of a robot, the optimal variable matrix representing a degree of a gain that a motion state of the robot has on a control mode of the robot;
calculate an angle deviation matrix and a noise deviation matrix according to the optimal feedback gain, the optimal variable matrix, the uncertainty, and a second state variable of the robot;
obtain control torque of the robot according to the second state variable, the optimal feedback gain, the angle deviation matrix, and the noise deviation matrix; and
control the robot according to the control torque.
